(19) United States
(12) Patent Application Publication
(10) Pub. No.: US 2025/0238507 A1
(43) Pub. Date: Jul. 24, 2025

(54) INFECTION NOTICE TRANSMISSION APPARATUS, METHOD, AND COMPUTER READABLE STORAGE MEDIUM

(71) Applicants: Akira OTSUKA, Kanagawa (JP); Yuhei OTSUBO, Kanagawa (JP); Premo, Inc., Tokyo (JP)

(72) Inventors: Akira OTSUKA, Kanagawa (JP); Yuhei OTSUBO, Saitama (JP)

(21) Appl. No.: 18/978,036

(22) Filed: Dec. 12, 2024

(30) Foreign Application Priority Data
Jan. 24, 2024 (JP) 2024-008688

(51) Int. Cl. G06F 21/56

(52) U.S. Cl. CPC G06F 21/561; G06F 2221/033

(57) ABSTRACT

Provided is an infection notice transmission apparatus permitted to send an infection notice to an external network if infected with a malicious program. The infection notice transmission apparatus may communicate with the external network by using a same global IP address as that used by one or more computers in a computer network. Communication from the infection notice transmission apparatus to the computer network is prohibited, and the infection notice transmission apparatus has a same software environment as that of the one or more computers.

The contents of the following patent application(s) are incorporated herein by reference: NO. 2024-008688 filed in JP on Jan. 24, 2024.

### BACKGROUND

### 1. Technical Field

The present invention relates to an infection notice transmission apparatus, a method, and a computer readable storage medium.

### 2. Related Art

Patent document 1 describes “an unauthorized access information collection system for monitoring unauthorized access to a honeynet constructed of plural honey pots (for example, a decoy server or a decoy network device for decoying a virus or an attacker, etc.) to collect unauthorized access information”. Patent document 2 describes “an attack information management technique for managing information collected by a decoy system”.

### PRIOR ART DOCUMENT

### Patent Document

Patent document 1: Japanese Patent Application Publication No. 2008-172548
Patent document 2: Japanese Patent Application Publication No. 2013-85124

### BRIEF DESCRIPTION OF THE DRAWINGS

FIG. 1 shows an entire computer network including an infection notice transmission apparatus 140 in one embodiment.

FIG. 2 shows one example of filtering settings for a communication control apparatus 100.

FIG. 3 shows a flowchart of a method executed if the infection notice transmission apparatus 140 is introduced.

FIG. 4 shows a flowchart of a method executed by the infection notice transmission apparatus 140.

FIG. 5 shows an action rule, implemented in a simulation model, of an attack side and a defense side.

FIG. 6 shows parameters set in a simulation.

FIG. 7 is a first graph indicating simulation results.

FIG. 8 is a second graph indicating a simulation result.

FIG. 9 shows an example of a computer 2000.

### DESCRIPTION OF EXEMPLARY EMBODIMENTS

The present invention will be described below through embodiments of the invention, but the following embodiments do not limit the invention according to the claims. In addition, not all of the combinations of functions described in the embodiments are essential to the solution of the invention.

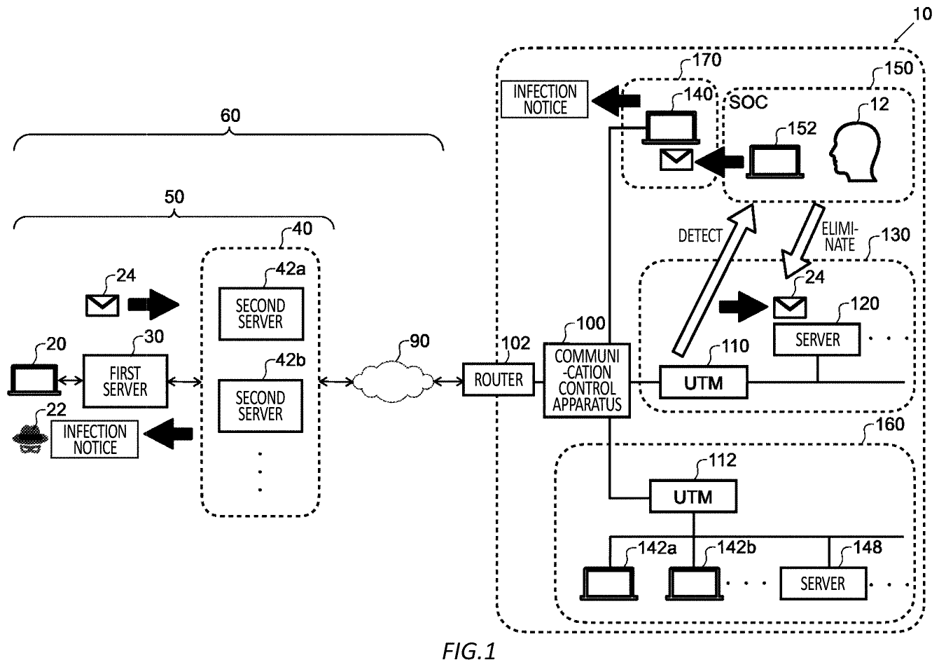

FIG. 1 shows an entire computer network including an infection notice transmission apparatus 140 in one embodiment. The infection notice transmission apparatus 140 is provided in an internal network 10. A router 102 is provided between the internal network 10 and an external network 60. A computer in the internal network 10 communicates with the external network 60 including Internet 90 via the router 102.

The internal network 10 is, for example, a network in an organization such as a company. The internal network 10 includes: a communication control apparatus 100; a DMZ 130; a computer network 160; and a network segment 170 including the infection notice transmission apparatus 140.

The computer network 160 is a private network in the internal network 10. The computer network 160 is, for example, an intranet in the organization. The computer network 160 includes: a UTM 112; a plurality of computers including a computer 142a and a computer 142b; and a server 148. The UTM 112 is unified threat management, and has, for example, security functions such as an antivirus function and a VPN.

The computer 142a and the computer 142b are, for example, terminals used by a general user in the organization. In the present embodiment, the computer 142a and the computer 142b may be collectively referred to as “computer(s) 142”. The computer 142 communicates with the external network 60 through the communication control apparatus 100 and the router 102. The computer 142 communicates with the external network 60 by using a global IP address assigned to the router 102.

The DMZ 130 is a network segment called a demilitarized zone on a network. The DMZ 130 is a network segment different from the computer network 160. The DMZ 130 is separated from the computer network 160 by the communication control apparatus 100. The communication control apparatus 100 may be a firewall apparatus. The DMZ 130 includes a UTM 110 and a server 120. In the present embodiment, the server 120 is a mail server. The DMZ 130 may include a server such as a WEB server in addition to the mail server. The UTM 110 is unified threat management, and has security functions such as an antivirus function and a VPN. In the present embodiment, the UTM 110 includes, as part of the antivirus function, a function for detecting a packet for a file containing a malicious program and for notifying a security operation center 150 of a fact that a threat has been detected together with information on the detected packet. For example, the UTM 110 detects a packet for an e-mail with a file containing a malicious program attached, and notifies the security operation center 150 of a fact that a threat has been detected together with information on the detected packet. The malicious program may be called malware. The malicious program is a program or a code having a malicious logic. The malicious program may be a computer virus or a worm. The present embodiment will mainly describe a mode in which opening a file attached to an e-mail causes infection with a malicious program, but a route of intrusion of a malicious program is not limited to an e-mail, and the present embodiment may also be applied to a mode in which a drive-by download attack causes infection with a malicious program and to a mode in which a hacker exploits vulnerability in a VPN or the like to intrude the internal network 10 and then causes infection with a malicious program.

The security operation center 150 is provided with a computer 152. In the security operation center 150, an operator 12 uses the computer 152 to monitor entire communication infrastructure in the internal network 10 and to perform security incident handling. In the present embodiment, in the security operation center 150, at least the communication control apparatus 100 is monitored and managed, and incident handling regarding a malicious program is performed.

The infection notice transmission apparatus 140 is provided to intentionally cause infection with a malicious program. The infection notice transmission apparatus 140 communicates with the external network 60 through the communication control apparatus 100 and the router 102. The infection notice transmission apparatus 140 communicates with the external network 60 by using the global IP address assigned to the router 102. In this manner, the infection notice transmission apparatus 140 communicates with the external network 60 by using a same global IP address as that used by one or more computers 142 in the computer network 160. On the other hand, the infection notice transmission apparatus 140 is connected to the computer network 160 via the communication control apparatus 100, and communication from the infection notice transmission apparatus 140 to the computer network 160 is prohibited.

The external network 60 includes an attacker side network 50, which is a computer network on an attacker side performing unauthorized access. The attacker side network 50 includes an attacker terminal 20, a first server 30, and a second server group 40.

The attacker terminal 20 is a terminal operated by an attacker 22. The attacker 22 uses the attacker terminal 20 to attack through the first server 30 and the second server group 40. For example, the attacker terminal 20 sends, through the first server 30 and the second server group 40, an e-mail with a file containing a malicious program attached. An e-mail 24 is sent to a mail server corresponding to a mail address to which the e-mail is to be sent, through the first server 30 and through any second server 42 in the second server group 40.

The present embodiment will describe a remote access trojan (also called “RAT”) as one example of a malicious program. First, the attacker 22 sends, for example, an e-mail with a title pretending to be related to business, with a file containing a malicious program attached under a file name pretending to be related to business. When a user of a computer which has received the e-mail performs operation to open the file attached to the e-mail, a malicious instruction is executed on the computer and the computer becomes infected with the malicious program. The computer becoming infected with the malicious program allows remote control of the computer. The computer infected with the malicious program regularly sends, to the first server 30 through the second server group 40, an infection notice indicating that the computer has been infected with the malicious program. The attacker 22 uses the attacker terminal 20 to remotely control the infected computer, thereby causing the infected computer to execute any instruction and illegally obtaining information from the infected computer. Additionally, the attacker 22 creates a list of IP addresses for accessing infected computers (sometimes called a list of infected terminals), and gains a profit by selling the list of infected terminals to others.

The present embodiment describes a case where the server corresponding to the mail address to which the e-mail 24, sent by the attacker 22, is to be sent is the server 120 in the internal network 10. The e-mail 24 is sent to the server 120 via the first server 30, the second server group 40, the Internet 90, the router 102, the communication control apparatus 100, and the UTM 110. When detecting a packet for the e-mail 24 as a threat, the UTM 110 notifies the security operation center 150 of information on the detected packet and of a fact that the threat has been detected. In the security operation center 150, the operator 12 eliminates the e-mail 24 in the server 120.

In the present embodiment, the e-mail 24 in the server 120 is provided to the infection notice transmission apparatus 140. For example, when obtaining information on the e-mail 24 specified as the threat, the infection notice transmission apparatus 140 obtains the e-mail 24 from the server 120. The e-mail 24 may be provided to the infection notice transmission apparatus 140 without need for operation by the operator 12. The e-mail 24 may be provided to the infection notice transmission apparatus 140 by connecting a storage medium having stored the e-mail 24 to the infection notice transmission apparatus 140 and having the infection notice transmission apparatus 140 read the e-mail 24 from the storage medium.

In response to the e-mail 24 being provided, the infection notice transmission apparatus 140 opens a file attached to the e-mail 24. Operation of the infection notice transmission apparatus 140 to open the file attached to the e-mail 24 may be performed without need for operation by the operator 12. The operation of the infection notice transmission apparatus 140 to open the file attached to the e-mail 24 may be performed through an operation by the operator 12. When the infection notice transmission apparatus 140 opens the file attached to the e-mail 24, the infection notice transmission apparatus 140 becomes infected with a malicious program.

The infection notice transmission apparatus 140 is permitted to send an infection notice to the external network 60 if infected with the malicious program. Therefore, the infection notice transmission apparatus 140 infected with the malicious program regularly sends, in accordance with operation of the malicious program, the infection notice to the first server 30 through the second server group 40. When receiving the infection notice, the attacker 22 uses the attacker terminal 20 to remotely control the infection notice transmission apparatus 140, and attempts to illegally obtain information from the infection notice transmission apparatus 140. Additionally, the attacker 22 creates a list of infected terminals including a global IP address for accessing the infection notice transmission apparatus 140, and attempts to sell the list of infected terminals to others.

The infection notice transmission apparatus 140 has a computer configuration similar to that of the computer 142 in the computer network 160, except that the infection notice transmission apparatus 140 has not stored any significant information. For example, the infection notice transmission apparatus 140 has a same software environment as that of the computer 142. Specifically, an operating system of the infection notice transmission apparatus 140 is the same as an operating system of the computer 142. More specifically, a version of the operating system of the infection notice transmission apparatus is the same as a version of the operating system of the one or more computers 142. Further, as described above, the infection notice transmission apparatus 140 communicates with the external network 60 by using the same global IP address as that used by the one or more computers 142 in the computer network 160. Therefore, it is difficult for the attacker 22 to realize that an intrusion target is not the computer 142 used by the general user but the infection notice transmission apparatus 140 provided to become intentionally infected with a malicious program.

Therefore, the attacker 22 remotely controls the infection notice transmission apparatus 140 and attempts to obtain information, but the infection notice transmission apparatus 140 has not stored any significant information, and therefore the attacker 22 cannot substantially obtain any useful information from the infection notice transmission apparatus 140. Further, since the communication from the infection notice transmission apparatus 140 to the computer network 160 is prohibited, the attacker 22 cannot zombify the infection notice transmission apparatus 140 to intrude the computer network 160. Therefore, the attacker 22 cannot substantially obtain any useful information from the internal network 10, either. Even if the global IP address for remotely controlling the infection notice transmission apparatus 140 is sold to others while being included in the list of infected terminals, the others cannot obtain any useful information from the infection notice transmission apparatus 140, which will decrease a value of the list of infected terminals in a trading market for lists of infected terminals. Therefore, the profit gained by the attacker 22 can be substantially decreased.

In addition, the attacker 22 will expend its human resources by making a RAT attack on the infection notice transmission apparatus 140. This can decrease opportunities for the attacker 22 to attack another network. That is, this can decrease opportunities for an attack made by the attacker 22 throughout a community.

If the attacker 22 realizes that the intrusion target is not the computer 142 and the attacker 22 changes network settings for the second server group 40 such that the second server group 40 does not receive the infection notice from the infection notice transmission apparatus 140, the first server 30 will no longer be able to receive an infection notice which may be sent from the computer 142 in the computer network 160, either. Therefore, even if the computer 142 becomes infected with a malicious program, the attacker 22 will no longer be able to receive the infection notice from the computer 142, and therefore the computer 142 will no longer be damaged. Therefore, the attacker 22 needs to select whether to accept to continuously receive the infection notice from the infection notice transmission apparatus 140 or to change a target of attack to another network after making settings for rejecting reception of the infection notice sent from the infection notice transmission apparatus 140.

In this manner, according to the infection notice transmission apparatus 140, it can be expected that causing the attacker 22 to expend its human resources decreases opportunities for an attack throughout the community. Further, even if the attacker 22 realizes presence of the infection notice transmission apparatus 140, it is possible to make it difficult for the attacker 22 to attack the organization provided with the internal network 10, which can reduce damage caused by the attack made by the attacker 22.

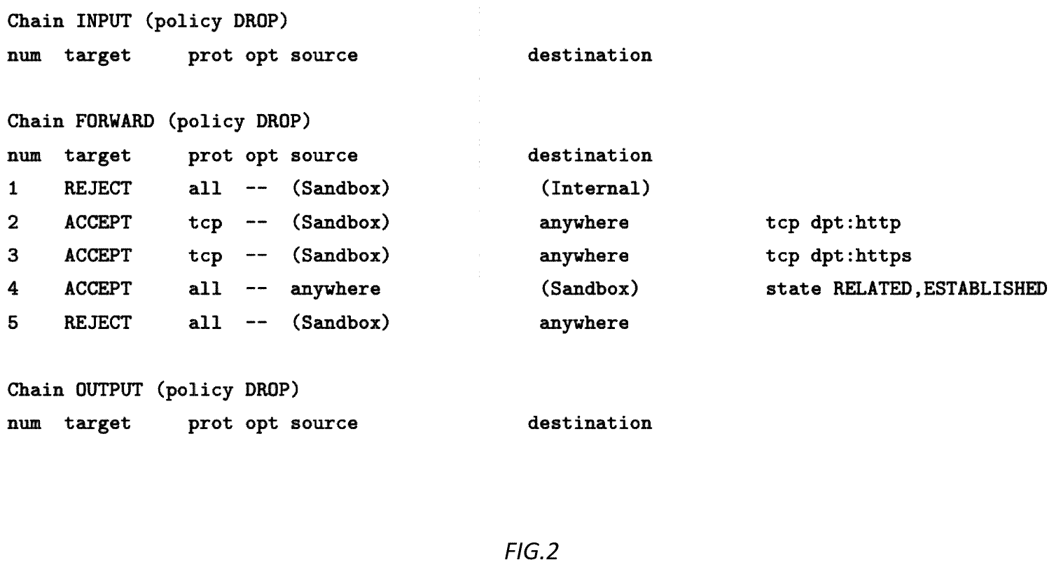

FIG. 2 shows one example of filtering settings for the communication control apparatus 100. Specifically, FIG. 2 shows settings, displayed by an iptables command, for a case where the communication control apparatus 100 is realized as a firewall apparatus by using Netfilter, which is a packet filtering function implemented in a LINUX (registered trademark) kernel.

In FIG. 2, “(sandbox)” represents a local IP address of the infection notice transmission apparatus 140, and “(Internal)” represents a network address of the computer network 160. As shown in FIG. 2, a basic policy for packet transfer is “DROP” (reject). Five rules corresponding to line numbers 1 to 5 are set for the packet transfer.

As shown in the line number 1, transfer of all packets from the infection notice transmission apparatus 140 to the computer network 160 is rejected. For packets other than the packets transferred from the infection notice transmission apparatus 140 to the computer network 160, as shown in the line number 2 and the line number 3, it is permitted to transfer tcp packets with destination ports http and https from the infection notice transmission apparatus 140, and as shown in the line number 4, it is permitted to transfer a packet of communication already established for communication to the infection notice transmission apparatus 140 and a packet related to the packet. As shown in the line number 5, for packets from the infection notice transmission apparatus 140, it is rejected to transfer packets other than the packets permitted for transfer in the line number 2 and the line number 3.

In this manner, the infection notice transmission apparatus 140 is connected to the computer network 160 via the communication control apparatus 100, and in accordance with a transfer policy of the communication control apparatus 100, communication from the infection notice transmission apparatus 140 to the computer network 160 is prohibited, and communication from the infection notice transmission apparatus 140 to the external network 60 is permitted. In FIG. 2, http or https communication is permitted for the communication from the infection notice transmission apparatus 140 to the external network 60, but permitted communication is not limited to this, and it is necessary to permit at least communication of a port number used to send an infection notice.

In the present embodiment, the communication from the infection notice transmission apparatus 140 to the computer network 160 is rejected by the communication control apparatus 100. As another method, it is also possible to incorporate, in the infection notice transmission apparatus 140 itself, network settings for rejecting the communication to the computer network 160. However, if such network settings are incorporated in the infection notice transmission apparatus 140 itself, in case of a RAT attack made by the attacker 22, the attacker 22 may be able to determine that the infection notice transmission apparatus 140 is not a computer used by a general user, by referring to the network settings set in the infection notice transmission apparatus 140. Therefore, it is preferable that the communication control apparatus 100 rejects the communication from the infection notice transmission apparatus 140 to the computer network 160.

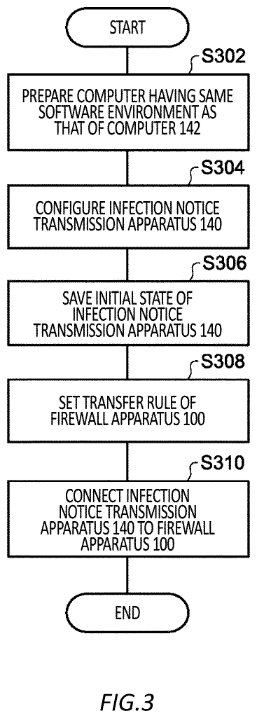

FIG. 3 shows a flowchart of a method executed if the infection notice transmission apparatus 140 is introduced. In S302, as a computer for configuring the infection notice transmission apparatus 140, a computer having a same software environment as that of the computer 142 is prepared. An OS of the computer prepared in S302 may be the same as an OS of the computer 142, and a version of the OS of the computer prepared in S302 may also be the same as a version of the OS of the computer 142. The computer prepared in S302 may have a same application software installed thereon as application software installed on the computer 142. The computer prepared in S302 may be a virtual machine. If the infection notice transmission apparatus 140 is configured with a physical computer, the computer prepared in S302 may have a same hardware configuration as that of the computer 142.

In S304, the infection notice transmission apparatus 140 is configured using the computer prepared in S302. For example, settings are made for, for example, assigning a local network address to the infection notice transmission apparatus 140. In S306, an initial state of the infection notice transmission apparatus 140 is saved. For example, if the infection notice transmission apparatus 140 is configured with a virtual machine, a snapshot representing a current operation state is created in S306. If the infection notice transmission apparatus 140 is configured with a physical computer, a restoration point for the initial state is set. For example, if software environment restoration software such as Faronics's Deep Freeze is utilized, the restoration software is activated. If a storage control apparatus such as Voom's Shadow 3 is utilized, the storage control apparatus is connected to a storage apparatus of the computer prepared in S302.

In S308, a packet transfer rule of the communication control apparatus 100 is set. Settings are made for permitting communication from the infection notice transmission apparatus 140 to the external network 60 and for rejecting communication from the infection notice transmission apparatus 140 to the computer network 160. In S310, the infection notice transmission apparatus 140 is connected to the communication control apparatus 100.

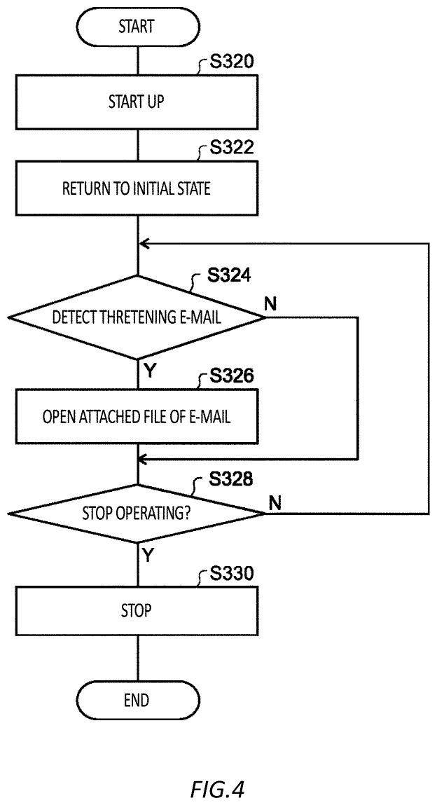

FIG. 4 shows a flowchart of a method executed by the infection notice transmission apparatus 140. It is assumed that, at a start of the present flowchart, the infection notice transmission apparatus 140 is stopped. In S320, the infection notice transmission apparatus 140 is started up. Timing at which the infection notice transmission apparatus 140 is started up may be timing earlier than opening time of an organization provided with the internal network 10 by a predetermined period of time.

In S322, the infection notice transmission apparatus 140 returns to its initial state. If the infection notice transmission apparatus 140 is configured with a virtual machine, the infection notice transmission apparatus 140 returns to the initial state based on the snapshot saved in S306. If the infection notice transmission apparatus 140 is configured with a physical computer, the infection notice transmission apparatus 140 returns to the restoration point set in S306. For example, if software environment restoration software such as Faronics's Deep Freeze is utilized, the infection notice transmission apparatus 140 returns, through restarting, to a state in which it was when the restoration software was activated. If a storage control apparatus such as Voom's Shadow 3 is utilized, the infection notice transmission apparatus 140 returns to the initial state before the storage control apparatus is connected, as a result of data written in the storage control apparatus being initialized.

In S324, the infection notice transmission apparatus 140 determines whether a threatening e-mail has been detected. For example, if notified, by the UTM 110, of a fact that the threatening e-mail has been detected, the infection notice transmission apparatus 140 determines that the threatening e-mail has been detected. If the infection notice transmission apparatus 140 determines, in S324, that the threatening e-mail has not been detected, processing continues to S328. The threatening e-mail may be, for example, an e-mail with a RAT type malicious program attached.

If the infection notice transmission apparatus 140 determines, in S324, that the threatening e-mail has been detected, it opens, in S326, a file attached to the e-mail detected in S324. As a result, the infection notice transmission apparatus 140 may become infected with the malicious program, and an infection notice may be sent to the first server 30. In this manner, if the e-mail with the file containing the RAT type malicious program attached is detected, the infection notice transmission apparatus 140 becomes infected with the RAT type malicious program by opening the file, and sends the infection notice to the external network 60. It is preferable that the infection notice transmission apparatus 140 opens the attached file within a predetermined period of time after the e-mail with the file attached is detected. On the other hand, it is preferable that the infection notice transmission apparatus 140 is prohibited from opening the attached file if a period of time equal to or longer than a predetermined period of time has elapsed since the e-mail containing the malicious program was detected. The predetermined period of time may be, for example, a period of time of about one to three days. This is because, if the first server 30 receives the infection notice from the infection notice transmission apparatus 140 after a period of time of about one to three days or more has elapsed since the e-mail was received, the attacker 22 may determine that infection may have been intentionally caused after measures were taken to monitor an attack, and refrain from attacking.

In S328, the infection notice transmission apparatus 140 determines whether to stop operating. For example, the infection notice transmission apparatus 140 determines to stop operating if predetermined time arrives. Specifically, the infection notice transmission apparatus 140 may determine to stop operating if closing time of the organization provided with the internal network 10 arrives. The infection notice transmission apparatus 140 may determine to stop operating if a predetermined period of time has elapsed since the closing time of the organization provided with the internal network 10. The predetermined period of time may be set at random. Stopping operation of the infection notice transmission apparatus 140 based on timing being based on the closing time of the organization may make it possible for the infection notice transmission apparatus 140 to appear as if it were a computer used by a general user if the attacker 22 intrudes the infection notice transmission apparatus 140 and refers to a system log of the infection notice transmission apparatus 140.

The infection notice transmission apparatus 140 does not need to stop operating at the predetermined time. The infection notice transmission apparatus 140 may return to the initial state each time a predetermined period of time has elapsed. The infection notice transmission apparatus 140 may return to the initial state each time it becomes infected with a predetermined number of malicious programs.

If the infection notice transmission apparatus 140 determines, in S328, to stop operating, it stops operating in S330. If the infection notice transmission apparatus 140 determines, in S328, not to stop operating, the processing returns to S324. In this manner, the infection notice transmission apparatus 140 returns to a predetermined operation state in which it has not been infected with a malicious program, at predetermined timing. After the infection notice transmission apparatus 140 becomes infected with a malicious program, the attacker 22 may sell, to others, a list of infected terminals including the infection notice transmission apparatus 140. However, if the infection notice transmission apparatus 140 subsequently returns to an operation state in which it has not been infected with a malicious program, it will no longer be possible to remotely control the infection notice transmission apparatus 140. Therefore, it can be expected to decrease a value of the list of infected terminals sold by the attacker 22, and thus it can be expected to decrease evaluation of the attacker 22 in a trading market for lists of infected terminals.

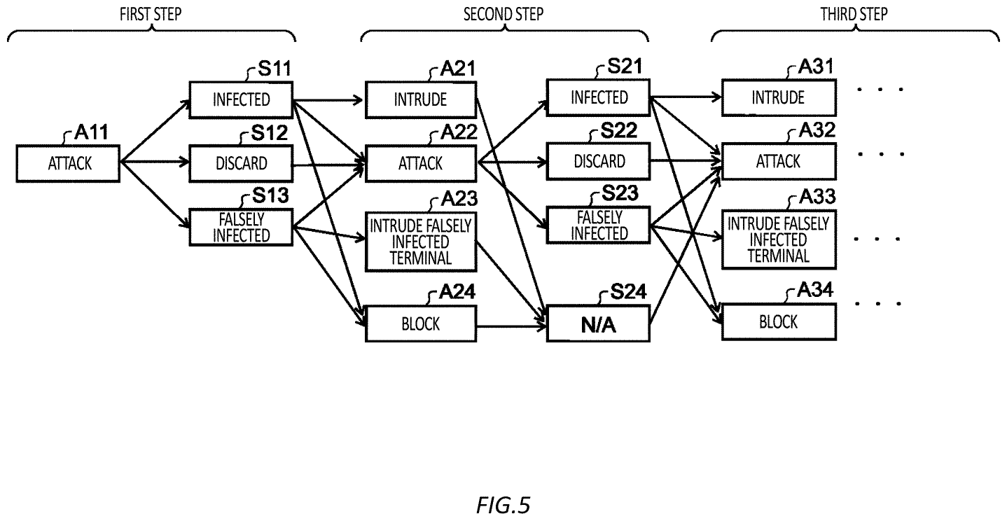

FIG. 5 to FIG. 8 describe a simulation performed to evaluate an effect of providing the infection notice transmission apparatus 140 intentionally infected with a malicious program against a RAT attack. In the present simulation, a number of at least one attacker was set to 1, and a number of at least one defense side target which may be a target of attack was set to N. In a description of the present simulation, the defense side targets are identified as T1, T2, . . . . TN. The attacker begins attacking by sending an e-mail with a malicious program attached. The attacker selects one defense side target of N defense side targets as an attack target, and starts attacking by sending the e-mail to the selected attack target. A level of attachment Att_{Ti} of the attacker to each of the defense side targets is set, and a probability that a defense side target Ti is selected as the attack target is Att_{Ti}/Att_{Tj}. Here, Σ represents addition of Att_{Tj}.

FIG. 5 shows an action rule, implemented in a simulation model, of an attack side and a defense side.

In a first step of the action rule, the attacker attacks by sending an e-mail (A11). In the present simulation, a probability that a recipient of the e-mail opens an attached file of the e-mail is set. As a result, a computer of a general user will become infected with a fixed probability, and an infection notice will be sent from the computer of the general user (S11). If the computer of the general user does not become infected, the e-mail will be discarded (S12), or a false infection notice will be sent (S13). Discard of the e-mail corresponds to, for example, a situation where the general user realizes that he/she has received an e-mail containing a malicious program and discards the e-mail. In the present simulation, a terminal, such as the infection notice transmission apparatus 140, which allows itself to become intentionally infected with a malicious program, is called a falsely infected terminal, and a fact that the falsely infected terminal becomes infected with the malicious program is called “false infection”. Transmission of the false infection notice (S13) corresponds to, for example, a state in which the e-mail is detected as a threat by the UTM 110, or the general user realizes that he/she has received the e-mail containing the malicious program and contacts the security operation center 150, and the attached file of the e-mail is opened by the infection notice transmission apparatus 140.

In a second step of the action rule, the attacker is in one of three states: (i) a state in which the attacker has received the infection notice; (ii) a state in which the attacker has received the false infection notice; or (iii) a state in which the attacker has received neither the infection notice nor the false infection notice.

If the attacker is in (i) the state in which the attacker has received the infection notice, a next action taken by the attacker will be one of: (a) intruding the infected terminal (A21); (b) selecting and attacking a next attack target (A22); or (c) blocking the attack target (A24). Here, “blocking the attack target” means that the attacker rejects reception of the infection notice sent from the infected terminal. If the attacker intrudes the infected terminal, gain values will be changed by predetermined values on both the attacker side and the defense side, and the next attack target will be selected and attacked in a next step.

Which action is taken by the attacker among (a), (b), and (c) is probabilistically selected based on the level of attachment to the target of attack. Specifically, it is assumed that a probability that the attack target is blocked is (1−Att_{Ti}), and a probability that the next attack target is selected and attacked is (1−Att_{Ti}) Att_{Ti}, and a probability that the infected terminal is intruded is Att_{Ti}².

If the attacker is in (ii) the state in which the attacker has received the false infection notice, the next action taken by the attacker will be, as with a case where the attacker is in (i) the state in which the attacker has received the infection notice, one of: (a) intruding the falsely infected terminal (A23); (b) selecting and attacking the next attack target (A22); or (c) blocking the attack target (A24). This is because, from a perspective of the attacker, it is not possible to distinguish whether the infection notice received by the attacker is the infection notice from the computer 142 or the infection notice transmission apparatus 140 in FIG. 1, for example. It is to be noted that, if the attacker intrudes the falsely infected terminal in the state in which the attacker has received the false infection notice, a gain for the defense side does not vary because there is no damage, while a gain for the attack side decreases. This is because, if the falsely infected terminal is intruded, there is a risk that an attack action is monitored. If the attacker is in (iii) the state in which the attacker has received neither the infection notice nor the false infection notice, the next action taken by the attacker will be selecting and attacking the next attack target (A22).

If the next attack target is selected in the second step, as in the first step, the infection notice will be sent from the computer of the general user (S21), the e-mail will be discarded (S22), or the false infection notice will be sent (S23). If the attacker takes, in the second step, an action other than the action of selecting and attacking the next attack target, the defense side will execute nothing (S24), and the attacker will select the next attack target in a third step (A32).

Next actions of S21, S22, and S23 in the second step are the same as next actions of S11, S12, and S13 in the first step. That is, an action, taken by the attacker, following S21 will be one of: (a) intruding the infected terminal (A31); (b) selecting and attacking a next attack target (A32); or (c) blocking the attack target (A34). An action, taken by the attacker, following S22 will be (b) selecting and attacking the next attack target (A32). An action, taken by the attacker, following S23 will be one of: (a) intruding the falsely infected terminal (A33); (b) selecting and attacking the next attack target (A32); or (c) adding the attack target to a rejection list (A34).

Transition of operation in the third step is the same as transition of operation in the second step. After that, the transition of the operation in the second step and transition of operation from the second step to the third step will be repeated.

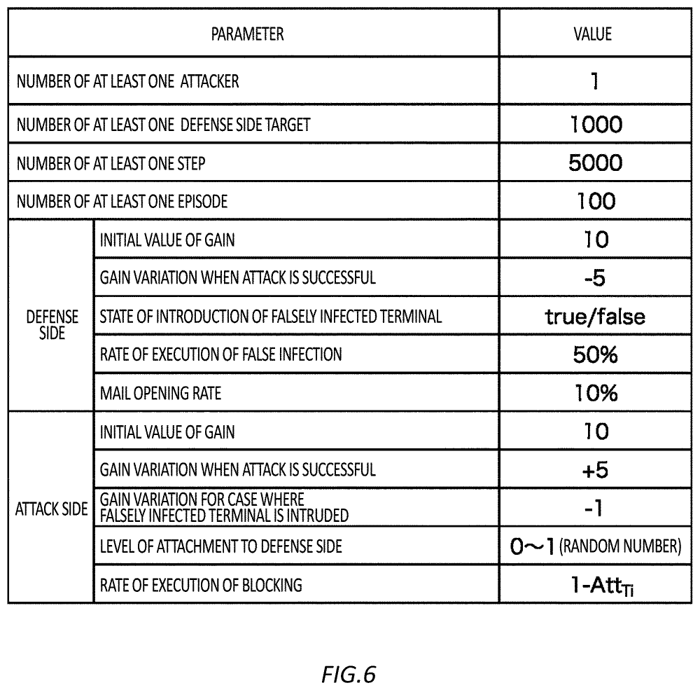

FIG. 6 shows parameters set in the simulation. As shown in FIG. 6, the number of at least one attacker is 1, and the number of at least one defense side target is 1000. A number of at least one step is 5000. A number of at least one episode is 100. The number of at least one episode is a number of at least one trial of the simulation. Since actions of the attacker and the attack targets are affected by random numbers, evaluation was performed by conducting 100 trials with different random number seeds and taking an average of the results.

Parameters for the defense side include “initial value of gain”, “gain variation when attack is successful”, “state of introduction of falsely infected terminal”, “rate of execution of false infection”, and “mail opening rate”. The “initial value of gain” was set to 10, and the “gain variation when attack is successful” was set to −5. As described above, if a terminal which has sent the false infection notice is intruded, there is no gain variation.

The “state of introduction of falsely infected terminal” indicates a state of introduction of terminal sending the false infection notice. The “state of introduction of falsely infected terminal” is set for each of the defense side targets. As described later, the evaluation was performed by conducting the simulation with a different rate of introduction of falsely infected terminal to each of the defense side targets.

The “rate of execution of false infection” indicates a probability that the false infection notice is sent if the e-mail is not opened. The “rate of execution of false infection” was set to 50%. The “mail opening rate” is a probability that the attached file of the e-mail is opened. The “mail opening rate” was set to 10%.

Parameters for the attack side include “initial value of gain”, “gain variation when attack is successful”, “gain variation for a case where falsely infected terminal is intruded”, “level of attachment to defense side”, and “rate of execution of blocking”. The “initial value of gain” was set to 10, and the “gain variation when attack is successful” was set to +5. The “gain variation for a case where falsely infected terminal is intruded” was set to −1.

The “level of attachment to defense side” is the level of attachment Att_{Ti} of the attacker to the defense side target Ti. The “level of attachment to defense side” was decided based on a pseudo random number for each episode. The “rate of execution of blocking” was set to 1−Att_{Ti}.

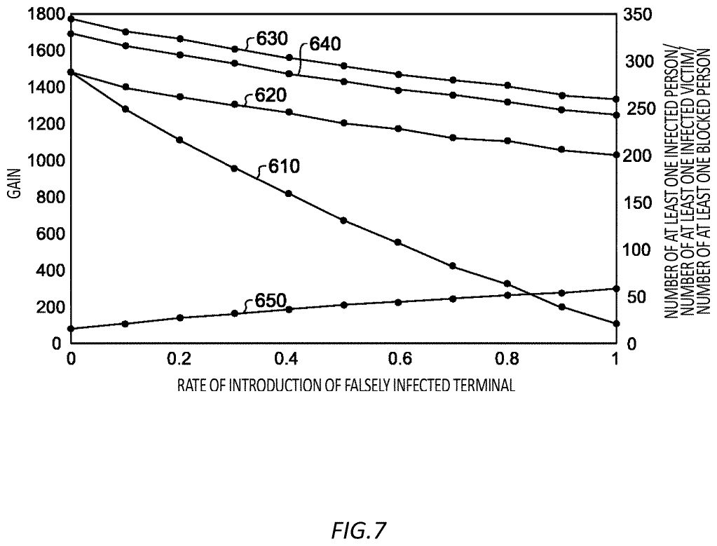

FIG. 7 is a first graph indicating simulation results. A horizontal axis of the graph shown in FIG. 7 represents a rate of introduction of falsely infected terminal. A vertical axis of the graph shown in FIG. 7 represents: a gain; and a number of at least one infected person, a number of at least one infected victim, and a number of at least one blocked person. A reference number 610 represents the gain for the attack side, a reference number 620 represents an amount of decrease in a gain for the defense side, a reference number 630 represents the number of at least one infected person indicating the number of at least one defense side target infected with a malicious program among the defense side targets, a reference number 640 represents the number of at least one infected victim indicating the number of at least one defense side target, for which intrusion has occurred, among the defense side targets, and a reference number 650 represents the number of at least one blocked person indicating the number of at least one defense side target blocked by the attacker among the defense side targets.

It can be seen from FIG. 7 that the higher the rate of introduction of falsely infected terminal is, the greater the number of at least one blocked person is, the smaller the number of at least one infected person and the number of at least one infected victim are, the smaller the amount of decrease in the gain for the defense side (so-called an amount of damage) is, and the smaller the gain for the attack side is. Especially, as indicated by a line of the reference number 610, it can be seen that the higher the rate of introduction of falsely infected terminal is, the more significantly the gain for the attack side decreases. That is, it can be understood that the attacker continuously accessing the falsely infected terminal has caused the attacker to expend its human resources. Therefore, it can be expected that introducing the falsely infected terminal reduces an amount of a RAT attack in a community.

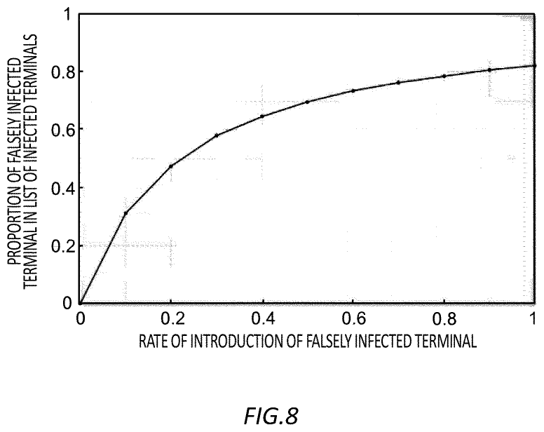

FIG. 8 is a second graph indicating a simulation result. A horizontal axis of the graph shown in FIG. 8 represents a rate of introduction of falsely infected terminal. A vertical axis of the graph shown in FIG. 8 represents a proportion of falsely infected terminal included in a list of infected terminals. It can be seen from FIG. 8 that the higher the rate of introduction of falsely infected terminal is, the higher the proportion of falsely infected terminal in the list of infected terminals is. Especially, it can be seen that, even if the rate of introduction of falsely infected terminal is 20%, about 50% of the terminals in the list of infected terminals are falsely infected terminals. Therefore, introducing the falsely infected terminal in an organization can significantly decrease the value of the list of infected terminals, and can undermine a profit of the attacker.

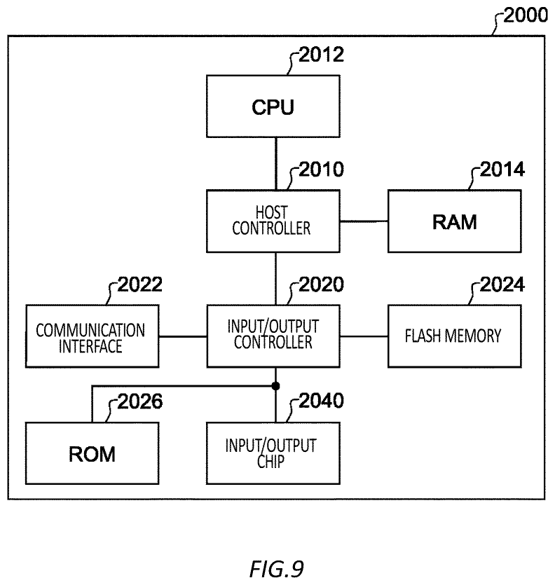

FIG. 9 shows an example of a computer 2000 in which a plurality of embodiments of the present invention may be entirely or partially embodied. Programs installed on the computer 2000 can cause the computer 2000: to function as a system according to the embodiments or each unit of the system or as an apparatus such as the infection notice transmission apparatus 140 or each unit of the apparatus; to execute operations associated with the system or each unit of the system or the apparatus or each unit of the apparatus; and/or to execute a process according to the embodiments or a stage of the process. Such programs may be executed by a CPU 2012 in order to cause the computer 2000 to execute a specific operation associated with some or all of the processing procedures and the blocks in the block diagrams described in the present specification.

The computer 2000 according to the present embodiment includes the CPU 2012 and a RAM 2014, which are mutually connected by a host controller 2010. The computer 2000 also includes a ROM 2026, a flash memory 2024, a communication interface 2022, and an input/output chip 2040. The ROM 2026, the flash memory 2024, the communication interface 2022, and the input/output chip 2040 are connected to the host controller 2010 via an input/output controller 2020.

The CPU 2012 operates in accordance with a program stored in the ROM 2026 and the RAM 2014, thereby controlling each unit.

The communication interface 2022 communicates with another electronic device via a network. The flash memory 2024 stores a program and data used by the CPU 2012 in the computer 2000. The ROM 2026 stores a boot program or the like executed by the computer 2000 during activation, and/or a program depending on hardware of the computer 2000. The input/output chip 2040 may also connect various input/output units such as a keyboard, a mouse, and a monitor, to the input/output controller 2020 via input/output ports such as a serial port, a parallel port, a keyboard port, a mouse port, a monitor port, a USB port, a HDMI (registered trademark) port.

The programs are provided via a network or a computer readable storage medium such as a CD-ROM, a DVD-ROM, or a memory card. The RAM 2014, the ROM 2026, or the flash memory 2024 is an example of the computer readable storage medium. The programs are installed on the flash memory 2024, the RAM 2014, or the ROM 2026, and executed by the CPU 2012. Information processing described in these programs is read by the computer 2000, and provides cooperation between the programs and the various types of hardware resources described above. An apparatus or a method may be configured by realizing operations or processing of information in accordance with a use of the computer 2000.

For example, if a communication is executed between the computer 2000 and an external device, the CPU 2012 may execute a communication program loaded onto the RAM 2014, and instruct the communication interface 2022 to execute communication processing based on processing described in the communication program. Under the control of the CPU 2012, the communication interface 2022 reads transmission data stored in a transmission buffering region provided in a recording medium such as the RAM 2014 or the flash memory 2024, sends the read transmission data to the network, and writes reception data received from the network into a reception buffering region or the like provided on the recording medium.

In addition, the CPU 2012 may cause all or a necessary portion of a file or a database stored in a recording medium such as the flash memory 2024 or the like to be read into the RAM 2014, and execute various kinds of processing on the data on the RAM 2014. Next, the CPU 2012 writes back the processed data into the recording medium.

Various types of information such as various types of programs, data, a table, and a database may be stored in the recording medium and may be subjected to information processing. The CPU 2012 may execute, on the data read from the RAM 2014, various kinds of processing including various kinds of operations, information processing, conditional judgement, conditional branching, unconditional branching, information search/replacement, or the like described in the present specification and designated by instruction sequences of the programs, and write back a result into the RAM 2014. In addition, the CPU 2012 may search for information in a file, a database, or the like in the recording medium. For example, if a plurality of entries each having an attribute value of a first attribute associated with an attribute value of a second attribute, is stored in the recording medium, the CPU 2012 may search for an entry having a designated attribute value of the first attribute that matches a condition from these plurality of entries, and read the attribute value of the second attribute stored in this entry, thereby obtaining the attribute value of the second attribute associated with the first attribute that satisfies a predetermined condition.

The programs or software module described above may be stored on the computer 2000 or in a computer readable storage medium near the computer 2000. A recording medium such as a hard disk or a RAM provided in a server system connected to a dedicated communication network or the Internet can be used as the computer readable storage medium. The programs stored in the computer readable storage medium may be provided to the computer 2000 via a network.

The programs installed on the computer 2000 and causing the computer 2000 to function as the infection notice transmission apparatus 140 may instruct, when executed by the computer, the CPU 2012 or the like to cause the computer 2000 to function as each unit of the infection notice transmission apparatus 140. The information processing described in these programs are read by the computer 2000 to cause the computer to function as each unit of the infection notice transmission apparatus 140, which is specific means realized by the cooperation of software and the various hardware resources described above. Then, these specific means realize arithmetic operations or processing of information according to the intended use of the computer 2000 in the present embodiment, and the infection notice transmission apparatus 140 is thereby constructed to be specific for the intended use.

Various embodiments have been described with reference to the block diagrams and the like. In the block diagrams, each block may represent (1) a stage of a process in which an operation is executed, or (2) each unit of the apparatus responsible for executing the operation. A specific stage and each unit may be implemented by a dedicated circuit, a programmable circuit supplied with computer readable instructions stored on a computer readable storage medium, and/or a processor supplied with computer readable instructions stored on a computer readable storage medium. The dedicated circuit may include a digital and/or analog hardware circuit, or may include an integrated circuit (IC) and/or a discrete circuit. The programmable circuit may include a reconfigurable hardware circuit including logical AND, logical OR, logical XOR, logical NAND, logical NOR, and another logical operation, and a memory element or the like such as a flip-flop, a register, a field programmable gate array (FPGA), a programmable logic array (PLA), or the like.

The computer readable storage medium may include any tangible device capable of storing instructions to be executed by an appropriate device, so that the computer readable storage medium having instructions stored therein constitutes at least a part of a product including instructions which may be executed to provide means for executing processing procedures or operations designated in the block diagrams. Examples of the computer readable storage medium may include an electronic storage medium, a magnetic storage medium, an optical storage medium, an electromagnetic storage medium, a semiconductor storage medium, and the like. More specific examples of the computer readable storage medium may include a floppy (registered trademark) disk, a diskette, a hard disk, a random access memory (RAM), a read only memory (ROM), an erasable programmable read only memory (EPROM or flash memory), an electrically erasable programmable read only memory (EEPROM), a static random access memory (SRAM), a compact disk read only memory (CD-ROM), a digital versatile disk (DVD), a BLU-RAY (registered trademark) disc, a memory stick, an integrated circuit card, or the like.

The computer readable instructions may include an assembler instruction, an instruction-set-architecture (ISA) instruction, a machine instruction, a machine dependent instruction, a microcode, a firmware instruction, state-setting data, or either of source code or object code described in any combination of one or more programming languages including an object oriented programming language such as Smalltalk (registered trademark), JAVA (registered trademark), C++, or the like, and a conventional procedural programming language such as a “C” programming language or a similar programming language.

Computer readable instructions may be provided to a processor of a general purpose computer, a special purpose computer, or another programmable data processing apparatus, or to programmable circuit, locally or via a local area network (LAN), wide area network (WAN) such as the Internet or the like, and a computer readable instruction may be executed to provide means for executing operations designated in the described processing procedures or block diagrams. Examples of the processor include a computer processor, a processing unit, a microprocessor, a digital signal processor, a controller, a microcontroller, and the like.

While the present invention has been described by way of the embodiments, the technical scope of the present invention is not limited to the above-described embodiments. It is apparent to persons skilled in the art that various alterations or improvements can be made to the above-described embodiments. It is also apparent from description of the claims that the embodiments to which such alterations or improvements are made can be included in the technical scope of the present invention.

It should be noted that the operations, procedures, steps, steps, and the like of each process executed by an apparatus, system, program, and method shown in the claims, embodiments, or diagrams can be realized in any order as long as the order is not indicated by “prior to,” “before,” or the like and as long as the output from a previous processing not used in a later processing. Even if the operation flow is described using phrases such as “first” or “next” for the sake of convenience in the claims, specification, or drawings, it does not necessarily mean that the process must be performed in this order.

### EXPLANATION OF REFERENCES

10: internal network
12: operator
20: attacker terminal
22: attacker
24: e-mail
30: first server
40: second server group
42: second server
50: attacker side network
60: external network
90: Internet
100: communication control apparatus
102: router
110: UTM
112: UTM
120: server
130: DMZ
140: infection notice transmission apparatus
142: computer
148: server
150: security operation center
152: computer
160: computer network
170: network segment
2000: computer
2010: host controller
2012: CPU
2014: RAM
2020: input/output controller
2022: communication interface
2024: flash memory
2026: ROM
2040: input/output chip.

What is claimed is:

1. An infection notice transmission apparatus permitted to send an infection notice to an external network if infected with a malicious program, wherein
the infection notice transmission apparatus communicates with the external network by using a same global IP address as that used by one or more computers in a computer network,
communication from the infection notice transmission apparatus to the computer network is prohibited, and
the infection notice transmission apparatus has a same software environment as that of the one or more computers.

2. The infection notice transmission apparatus according to claim 1, wherein
the infection notice transmission apparatus is connected to the computer network via a communication control apparatus, and
in accordance with a transfer policy of the communication control apparatus,
the communication from the infection notice transmission apparatus to the computer network is prohibited, and
communication from the infection notice transmission apparatus to the external network is permitted.

3. The infection notice transmission apparatus according to claim 1, wherein
an operating system of the infection notice transmission apparatus is the same as an operating system of the one or more computers.

4. The infection notice transmission apparatus according to claim 3, wherein
a version of the operating system of the infection notice transmission apparatus is the same as a version of the operating system of the one or more computers.

5. The infection notice transmission apparatus according to claim 1, wherein
if an e-mail with a file containing a malicious program attached is detected, the infection notice transmission apparatus becomes infected with the malicious program by opening the file.

6. The infection notice transmission apparatus according to claim 1, wherein
if a file containing a RAT type malicious program is detected, the infection notice transmission apparatus becomes infected with the RAT type malicious program by opening the file.

7. The infection notice transmission apparatus according to claim 5, wherein
the infection notice transmission apparatus opens the file within a predetermined period of time after the e-mail with the file attached is detected.

8. The infection notice transmission apparatus according to claim 6, wherein
the infection notice transmission apparatus is prohibited from opening the file if a predetermined period of time has elapsed since an e-mail containing a malicious program was detected.

9. The infection notice transmission apparatus according to claim 1, wherein
the infection notice transmission apparatus returns to a predetermined operation state, in which the infection notice transmission apparatus has not been infected with a malicious program, at a predetermined timing.

10. The infection notice transmission apparatus according to claim 2, wherein
an operating system of the infection notice transmission apparatus is the same as an operating system of the one or more computers.

11. The infection notice transmission apparatus according to claim 10, wherein
a version of the operating system of the infection notice transmission apparatus is the same as a version of the operating system of the one or more computers.

12. The infection notice transmission apparatus according to claim 2, wherein
if an e-mail with a file containing a malicious program attached is detected, the infection notice transmission apparatus becomes infected with the malicious program by opening the file.

13. The infection notice transmission apparatus according to claim 3, wherein
if an e-mail with a file containing a malicious program attached is detected, the infection notice transmission apparatus becomes infected with the malicious program by opening the file.

14. The infection notice transmission apparatus according to claim 2, wherein
if a file containing a RAT type malicious program is detected, the infection notice transmission apparatus becomes infected with the RAT type malicious program by opening the file.

15. The infection notice transmission apparatus according to claim 3, wherein
if a file containing a RAT type malicious program is detected, the infection notice transmission apparatus becomes infected with the RAT type malicious program by opening the file.

16. The infection notice transmission apparatus according to claim 12, wherein
the infection notice transmission apparatus opens the file within a predetermined period of time after the e-mail with the file attached is detected.

17. The infection notice transmission apparatus according to claim 14, wherein
the infection notice transmission apparatus is prohibited from opening the file if a predetermined period of time has elapsed since an e-mail containing a malicious program was detected.

18. The infection notice transmission apparatus according to claim 2, wherein
the infection notice transmission apparatus returns to a predetermined operation state, in which the infection notice transmission apparatus has not been infected with a malicious program, at a predetermined timing.

19. A method executed in an infection notice transmission apparatus permitted to send an infection notice to an external network if infected with a malicious program, the method comprising:
communicating with the external network by using a same global IP address as that used by one or more computers in a computer network; and becoming infected with a malicious program in a state in which communication from the infection notice transmission apparatus to the computer network is prohibited; and
sending the infection notice to the external network in accordance with operation of the malicious program if the infection notice transmission apparatus is infected with the malicious program, wherein
the infection notice transmission apparatus has a same software environment as that of the one or more computers.

20. A non-transitory computer readable storage medium having stored thereon a computer program which, when executed by a computer, causes the computer to function as an infection notice transmission apparatus permitted to send an infection notice to an external network if infected with a malicious program, wherein
the computer program causes the computer to execute:
communicating with the external network by using a same global IP address as that used by one or more other computers in a computer network; and becoming infected with a malicious program in a state in which communication from the computer to the computer network is prohibited; and
sending the infection notice to the external network in accordance with operation of the malicious program if the computer is infected with the malicious program, and
the computer has a same software environment as that of the one or more other computers.
